(19) United States
(12) Patent Application Publication
(10) Pub. No.: US 2017/0013419 A1
(43) Pub. Date: Jan. 12, 2017

(54) RADIOFREQUENCY TRANSMISSION DEVICE

(71) Applicants: CONTINENTAL AUTOMOTIVE FRANCE, Toulouse (FR); CONTINENTAL AUTOMOTIVE GmbH, Hannover (DE)

(72) Inventors: Jean-Christophe BOUTHINON, Cugnaux (FR); Dawid DURKA, Toulouse (FR)

(21) Appl. No.: 15/198,080

(22) Filed: Jun. 30, 2016

(30) Foreign Application Priority Data
Jul. 8, 2015 (FR) 1556479

(51) Int. Cl. H04W 4/04; H04B 5/00

(52) U.S. Cl. CPC H04W 4/046; H04B 5/0081

(57) ABSTRACT

A radiofrequency transmission device (D′) includes: a transmission unit (10) for transmitting a voltage signal (S) in pulsed form; a radiofrequency antenna (A); filtering elements (30′); and a voltage source (Vcc), wherein the filtering elements (30′) include:
“n” coils (B₁, B₂ . . . Bₙ), electrically connected in series, of which (n−1) coils each have a natural resonance frequency such that:

f_{RLi}=i×f_{F}
each having an inductance (Lᵢ) such that, at the predetermined fundamental frequency:

L_{TOT}=L₁+L₂+ . . . Lᵢ+ . . . Lₙ=Z_{TOT}=Z₁+Z₂+ . . . Zᵢ+ . . . Zₙ

and

Lᵢ=Zᵢ

where
f_{RLi} Is the natural resonance frequency of the i-th coil
i is a number varying from 2 to n,
L_{TOT} is the total inductance of the n coils,
Lᵢ is the inductance of the i-th coil,
Z_{TOT} is the total impedance of the n coils,
Zᵢ is the impedance of the i-th coil,
n is an integer greater than zero.

### FIELD OF THE INVENTION

The invention relates to a radiofrequency transmission device. The term “radiofrequency transmission device” is taken to mean any “hands free” access badge for accessing a motor vehicle, which communicates by radio waves with an on-board electronics unit in said vehicle, in order to unlock the doors of the vehicle without any need for the user to actuate the doors of said vehicle manually; the badge may take the form of either a card or a mobile phone.

### BACKGROUND OF THE INVENTION

The term “radiofrequency transmission device” is also taken to mean a tire pressure sensor of a motor vehicle, either attached to the rim of a wheel of said vehicle, or placed in the tread of a tire of the vehicle. Said tire pressure sensor communicates by radio waves with a central on-board electronics unit in the vehicle in order to send pressure (and temperature) measurements made by said sensor in the tire to said unit, thus warning the user of any under-inflation of the tire.

Said radiofrequency transmission devices transmit radio waves at a predetermined nominal transmission frequency, referred to herein as the fundamental frequency f_{F}.

A radiofrequency transmission device D of this type is shown in FIG. 1, and takes the form of an electronic circuit comprising, among other components:
a voltage supply source Vcc, which may be, for example, a battery, or the voltage drawn from the vehicle battery,
a transmission unit 10 for transmitting a voltage signal S, comprising an oscillator and a power amplifier,
a radiofrequency antenna A,
matching means M1 for matching the transmission frequency of the antenna A to the value of the predetermined fundamental frequency f_{F},
filtering means 30, generally comprising at least one band-pass filter.

The transmission frequency matching means generally comprise:
a matching coil L, connected electrically in series with:
   a first matching unit 20, to match the frequency of the power amplifier of the transmission unit 10 to the fundamental frequency f_{F}, supplied by the voltage source Vcc and connected, on the one hand, to said transmission unit 10, and, on the other hand, to the filtering means 30. Said first matching unit 20 generally comprises (see FIG. 2) at least a first matching capacitor C1 connected to the supply source Vcc and to the ground, a coil Lx connected to the supply source Vcc and to a junction point J, a second matching capacitor C2 connected to the junction point J and to the ground, and a third capacitor C3 connected to the junction point J and to the input of the filtering means 30,
   and a second matching unit 40 for matching the transmission frequency of the antenna A, connected to the output of the filtering means 30, comprising one or more matching capacitors (not shown), and connected electrically to the radiofrequency antenna A.

Said radiofrequency transmission device D is known to those skilled in the art and will not be detailed further here.

The transmission unit 10 is supplied with voltage by the voltage supply source Vcc, and generates a pulsed voltage signal S (FIG. 1) whose predetermined fundamental frequency f_{F} is substantially equal, because of the transmission frequency matching means M1, to the nominal transmission frequency of the antenna A of the radiofrequency transmission device D.

The generation of this pulsed voltage signal S is accompanied by the parallel generation of harmonic parasitic currents, that is to say periodic parasitic voltage signals whose frequencies are multiples of the predetermined fundamental frequency f_{F}, that is to say frequencies equal to 2, 3, 4, and 5 times the predetermined fundamental frequency f_{F}.

Said parasitic voltage signals are propagated throughout the electronic circuit of the radiofrequency transmission device D, and make the electronic circuit resonant. More precisely, the radiofrequency transmission device D then transmits radio waves at other undesired parasitic frequencies, in other words parasitic radio waves, in addition to the radio wave at the fundamental frequency f_{F}. Said radio waves at the parasitic frequencies are propagated throughout the electronic circuit, said circuit generally consisting of a printed circuit, said waves being propagated through the copper tracks of the printed circuit, making the printed circuit resonant at the parasitic frequencies.

These parasitic radio waves may interfere with other on-board electronic equipment in the motor vehicle and may affect its operation.

The acceptable frequencies of on-board radiofrequency transmission devices D in motor vehicles are defined by the current national regulations in force in each country.

If said radiofrequency transmission devices D transmit radio waves at frequencies which are not legally authorized, the motor vehicle can no longer be officially approved.

It is therefore essential to prevent the transmission of these parasitic radio waves by the radiofrequency transmission device D.

For this purpose, according to the prior art, the filtering means 30 comprise a band-pass filter, generally in the form of an electronic circuit comprising capacitors and coils connected (not shown) in series and/or to the ground. This band-pass filter is matched in order to filter the voltage signals at parasitic frequencies and to allow only the voltage signal S at the predetermined fundamental frequency f_{F} to pass to the radiofrequency antenna A.

The filtering provided in this way must be impedance matched before being connected to the antenna A. This impedance is adjusted on the basis of the fundamental frequency, by means of the second connected frequency matching unit 40.

However, since this band-pass filter is connected to the ground of the electronic circuit, the voltage signals at parasitic frequencies may be propagated in the ground plane of the radiofrequency transmission device D, which, in turn, then starts to radiate at said parasitic frequencies.

Furthermore, said low-pass filter requires a large number of electronic components, which is costly.

### SUMMARY OF THE INVENTION

The invention proposes a radiofrequency transmission device which is free of the drawbacks of the prior art, that is to say a device which does not transmit parasitic radio waves. Additionally, the radiofrequency transmission device according to the invention is inexpensive.

The invention therefore proposes a radiofrequency transmission device comprising:
a transmission unit for transmitting a pulsed voltage signal at a predetermined fundamental frequency, generating parasitic voltage signals at frequencies which are multiples of the predetermined fundamental frequency,
a radiofrequency antenna,
matching means for matching the transmission frequency of the radiofrequency antenna to the predetermined fundamental frequency,
filtering means for filtering the parasitic voltage signals,
a voltage source, connected to the matching means and supplying voltage to the transmission unit,
   said device according to the invention being remarkable in that:
the filtering means are electrically connected, on the one hand, to the transmission unit, and, on the other hand, to the matching means, and
   in that said filtering means comprise:
a number “n” of coils, electrically connected in series with each other, of which (n−1) coils have a natural resonance frequency such that:

f_{RLi}=i×f_{F}

where
f_{RLi} is the natural resonance frequency of the i-th coil,
i is a number varying from 2 to n,
f_{F} is the predetermined fundamental frequency
   each having an inductance such that, at the predetermined fundamental frequency,

L_{TOT}=L₁+L₂+ . . . Lᵢ+ . . . Lₙ=Z_{TOT}=Z₁+Z₂+ . . . Zᵢ+ . . . Zₙ

and

Lᵢ=Zᵢ

where
L_{TOT} is the total inductance of the “n” coils,
Lᵢ is the inductance of the i-th coil,
Z_{TOT} is the total impedance of the “n” coils,
Zᵢ is the impedance of the i-th coil,
n is an integer greater than zero.

In a preferred embodiment of the invention, the filtering means comprise three coils.

Preferably, the predetermined fundamental frequency is in the range from 310 MHz to 434 MHz.

The invention is equally applicable to:
any wheel unit or any “hands free” access badge for accessing a motor vehicle, comprising a radiofrequency transmission device according to any of the characteristics listed above.

Finally, the invention concerns any vehicle comprising a radiofrequency transmission device according to any of the characteristics listed above.

### BRIEF DESCRIPTION OF THE DRAWINGS

Other characteristics and advantages of the invention will be apparent from a reading of the following description and from an examination of the appended drawings, in which:

FIG. 1, explained above, shows schematically the radiofrequency transmission device D according to the prior art,

FIG. 2, explained above, shows schematically the first matching unit 20,

FIG. 3 shows schematically the radiofrequency transmission device D′ according to the invention,

FIG. 4 shows schematically the filtering means 30′ according to the invention,

FIG. 5 shows in graphic form the attenuation of the intensity of radiofrequency transmission at the resonance frequencies corresponding to the inductances of the coil, according to the invention,

FIG. 6 shows in graphic form the resonance frequency of the coils according to the value of the inductance of said coils, according to the invention.

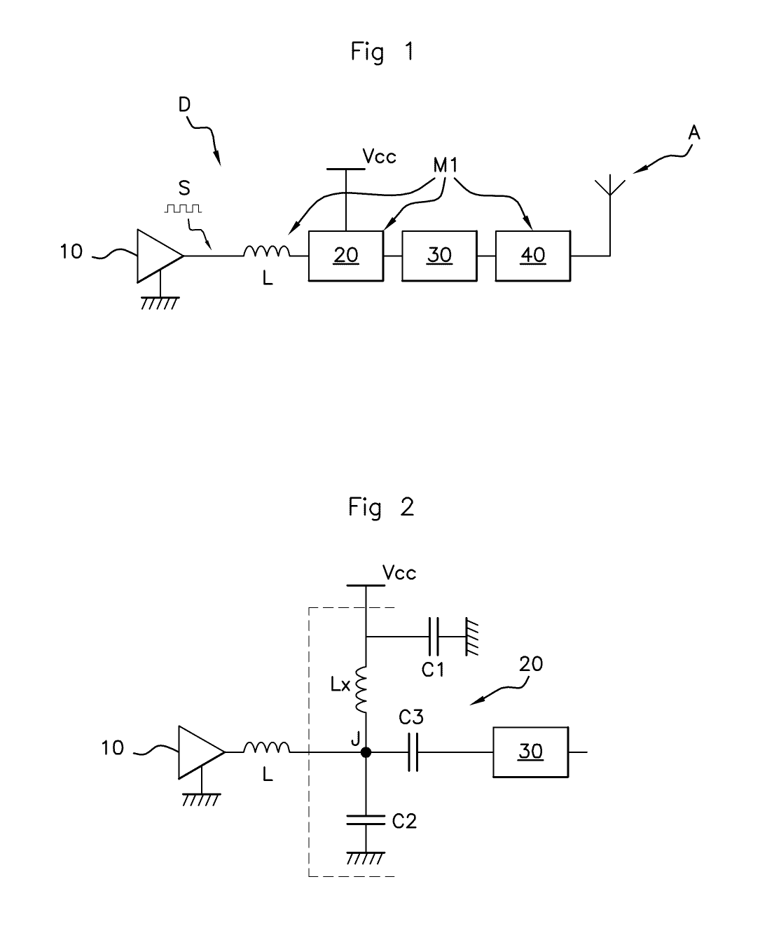

### DETAILED DESCRIPTION OF THE INVENTION

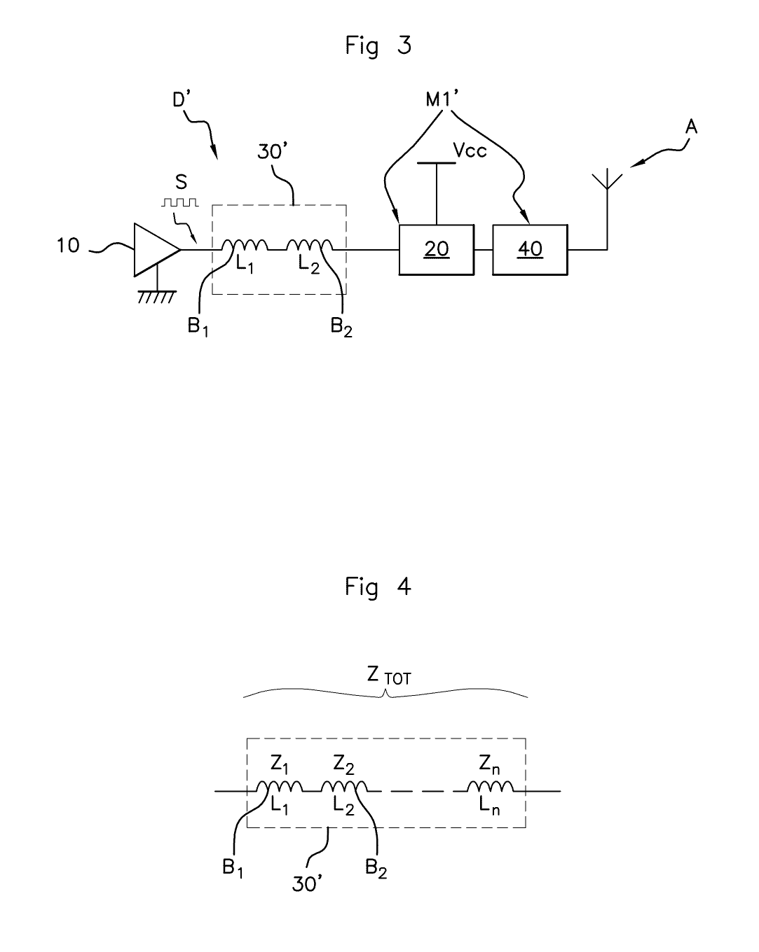

The invention proposes a radiofrequency transmission device D′, shown in FIG. 3.

The radiofrequency transmission device D′ comprises:
a voltage supply source Vcc, which may be, for example, a battery, or the voltage drawn from the vehicle battery,
a transmission unit 10 for transmitting a voltage signal S, comprising an oscillator and a power amplifier,
matching means M1′ for matching the transmission frequency of the antenna A to the fundamental frequency f_{F}, supplied by a voltage source Vcc,
and a radiofrequency antenna A connected to the matching means M1.

As explained above, the transmission unit 10 is supplied with voltage by the voltage supply source Vcc, and generates a voltage signal S (see FIG. 3) in the form of successive pulses, that is to say a pulsed voltage signal S, accompanied by the parallel generation of what are known as “harmonic” parasitic currents, that is to say periodic parasitic voltage signals whose frequencies are multiples of the predetermined fundamental frequency f_{F}, that is to say frequencies equal to 2, 3, 4, and 5 times the predetermined fundamental frequency f_{F}.

In order to overcome this drawback, the radiofrequency transmission device D′ according to the invention also comprises filtering means 30′, electrically connected, on the one hand, to the transmission unit 10 and, on the other hand, to transmission frequency matching means M1′.

According to the invention, the matching means M1′ comprise:
a first matching unit 20 for matching the frequency of the power amplifier of the transmission unit 10 to the fundamental frequency f_{F}, supplied by the voltage source Vcc and connected, on the one hand, to said filtering means 30′, and, on the other hand, to a second matching unit 40. Said first matching unit 20 generally comprises (see FIG. 2), as in the prior art, at least a first matching capacitor C1 connected to the supply source Vcc and to the ground, a coil Lx connected to the supply source Vcc and to a junction point J, a second matching capacitor C2 connected to the junction point J and to the ground, and a third capacitor C3 connected to the junction point J and to the input of the second matching unit 40,
a second matching unit 40 for matching the transmission frequency of the antenna A, connected to the output of the first matching unit 20, comprising one or more matching capacitors (not shown), and connected electrically to the radiofrequency antenna A.

The filtering means 30′ according to the invention comprise “n” coils B₁, B₂, . . . Bᵢ, . . . Bₙ, electrically connected in series (see FIG. 4) with each other.

Advisably, according to the invention, “(n−1)” coils, for example B₂, B₃, . . . Bᵢ, . . . Bₙ, each have an inductance Lᵢ having a natural resonance frequency f_{RLi} corresponding to a harmonic of the predetermined fundamental frequency f_{F}.

More particularly:

f_{RLi}=i×f_{F}

where
f_{RLi} is the natural resonance frequency of the i-th inductance,
i is a number varying from 2 to n,
f_{F} is the predetermined fundamental frequency.

In other words, each of the “(n−1)” coils resonates at a frequency equal to a harmonic of the predetermined fundamental frequency f_{F}, that is to say at one of the parasitic frequencies. This has the effect of attenuating the intensity of said harmonics.

Advantageously, each of the n coils has an impedance value Zi such that the total sum Z_{TOT} of the impedance values (Zi) of the filtering means 30′ measured at the predetermined fundamental frequency f_{F} is equal to the total sum of the values of inductance L_{TOT}:

Z_{TOT}=Z₁+Z₂+ . . . Zᵢ+ . . . Zₙ=L_{TOT}=L₁+L₂+ . . . Lᵢ+ . . . Lₙ

where
Z_{TOT} is the total impedance of the “n” coils, measured at the predetermined fundamental frequency f_{F},
Zᵢ is the impedance of the “i-th” coil Bᵢ,
L_{TOT} is the total inductance of the “n” coils,
Lᵢ is the inductance of the “i-th coil” Bᵢ.

The “n−1” coils B₂, B₃, B₄ . . . Bₙ then serve to filter the parasitic frequencies without modifying the value of the total impedance Z_{TOT} of the network formed by the “n” coils of the filtering means M1′, which remains equal to the impedance Z_{TOT} measured at the predetermined fundamental frequency f_{F}.

This is because, for each coil Bᵢ, the impedance Zᵢ of said coil tends toward infinity, when measured at the resonance frequency f_{RLi}, which is natural to said coil; that is to say, Zᵢ=∞ measured at the resonance frequency f_{RLi} of the coil Bᵢ.

However, at the predetermined fundamental frequency f_{F}, which is the operating frequency of the filtering means 30′, the impedance Zᵢ of each coil Bᵢ is equal to its inductance Lᵢ, and therefore:

Zᵢ=Lᵢ

For its part, the remaining coil, for example the first coil B₁, does not have an inductance L₁ whose resonance frequency is equal to a multiple of the predetermined fundamental frequency f_{F}.

The remaining coil, that is to say the first coil B₁, has an impedance Z₁, such that it satisfies the equation

Z₁=Z_{TOT}−Z₂− . . . Zᵢ− . . . Zₙ

where
Z_{TOT} is the total impedance of the “n” coils, measured at the predetermined fundamental frequency f_{F},
Zi is the impedance of the “i-th” coil,
   and an inductance L₁ such that, at the predetermined fundamental frequency f_{F}, there is an inductance L₁ which is equal to the impedance Z₁:

L₁=Z₁

Thus the parasitic frequencies are filtered by means of the (n−1) coils B₁ . . . Bₙ of the filtering means 30′, and are no longer propagated in the transmission device D′, as was the case in the prior art.

With the radiofrequency transmission device D′ according to the invention, therefore, the radiofrequency antenna A transmits at the predetermined fundamental frequency f_{F}, and does not transmit radio waves at the parasitic frequencies.

Additionally, the electronic circuit no longer transmits radio waves at the parasitic frequencies via the ground planes or the copper tracks of its constituent printed circuit, as was the case in the prior art.

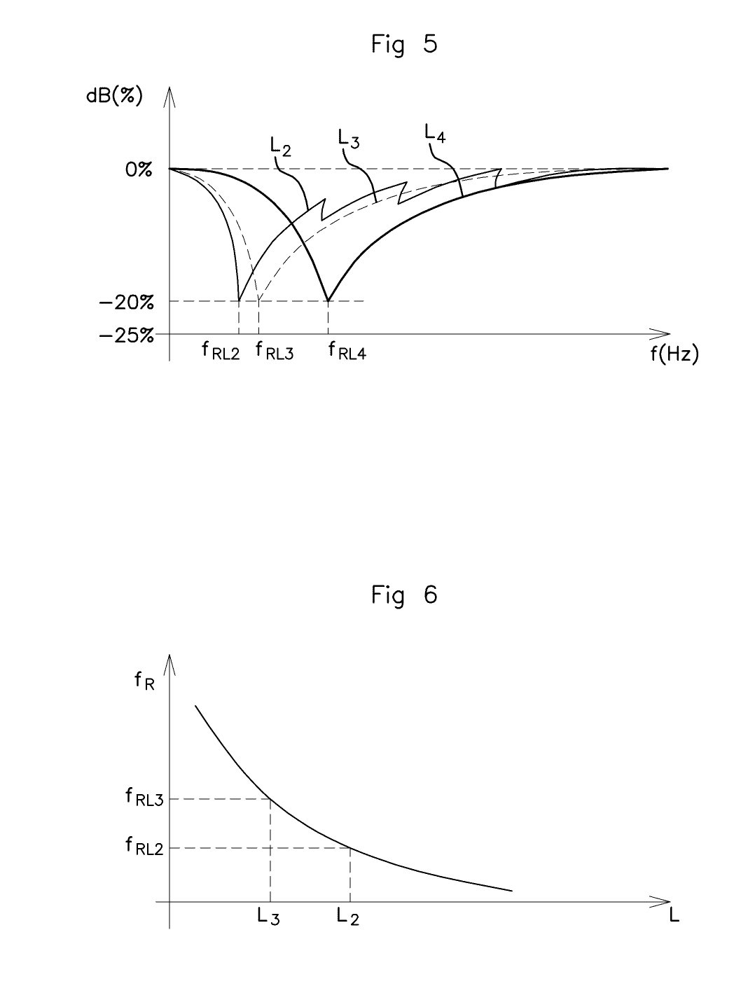

FIG. 5 shows the frequency amplitude reduction of the coils B₂, B₃, B₄ as a function of their inductance L₂, L₃ and L₄.

The greatest frequency amplitude reduction is obtained at the resonance frequency f_{RL2}, f_{RL3}, f_{RL4} of said coils B₂, B₃, B₄.

According to the invention, the inductances L₂, L₃, L₄ of the coils are selected in such a way that their natural resonance frequencies f_{RL2}, f_{RL3}, f_{RL4} are substantially equal to the parasitic frequencies transmitted by the transmission unit 10.

FIG. 6 shows the curve of the resonance frequency f_{R} of the coils as a function of their inductance L.

For example, in the case where n=3, for the second coil B₂, the inductance L₂ is selected in such a way that the resonance frequency of said second coil B₂ is equal to twice the predetermined fundamental frequency f_{F}, and therefore:

f_{RL2}=2×f_{F}

Similarly, for the third coil B₃, the inductance L₃ is selected in such a way that the resonance frequency of the third coil B₃ is equal to three times the predetermined fundamental frequency f_{F}, i.e.:

f_{RL3}=3×f_{F}

For a given inductance Lᵢ, the impedance Zᵢ is determined as follows: Zᵢ=Lᵢ when the impedance Zᵢ is measured at the predetermined fundamental frequency f_{F}.

Therefore Z₂=L₂ at the predetermined fundamental frequency f_{F} and
Z₃=L₃ at the predetermined fundamental frequency f_{F}.

Then, a predetermined fundamental frequency f_{F} corresponds to a total impedance Z_{TOT} of the filtering means M1′, that is to say the total impedance of the three-coil network, where Z_{TOT}=L_{TOT} at said predetermined fundamental frequency f_{F}.

The impedance Z₁ of the first coil B₁ is then selected in such a way that:

Z₁=Z_{TOT}−Z₂−Z₃

The inductance L₁ of the first coil B₁ is then a function of the impedance Z₁, where L₁=Z₁ at the predetermined fundamental frequency f_{F}.

Thus, with the filtering means 30′ according to the invention, a network of “n” coils can be used to filter the parasitic frequencies transmitted by the transmission unit 10 by a careful selection of the characteristics (impedance, inductance) of said coils as a function of the predetermined fundamental frequency.

The transmission device D′ according to the invention no longer resonates at the parasitic frequencies, and the antenna A transmits radio waves at the desired transmission frequency only.

1. A radiofrequency transmission device (D′) comprising:
a transmission unit (10) for transmitting a pulsed voltage signal (S) at a predetermined fundamental frequency (f_{F}), generating parasitic voltage signals at frequencies which are multiples of the predetermined fundamental frequency (f_{F}),
a radiofrequency antenna (A),
matching means (M1′) for matching the transmission frequency of the antenna (A) to the value of the predetermined fundamental frequency (f_{F}),
filtering means (30′) for filtering the parasitic voltage signals,
a voltage source (Vcc), connected to the matching means (M1) and supplying voltage to the transmission unit (10),
wherein:
the filtering means (30′) are electrically connected to the transmission unit (10), and to the matching means (M1′), and
said filtering means (30′) comprise:
a number “n” of coils (B₁, B₂, Bᵢ . . . Bₙ), electrically connected in series with each other, of which (n−1) coils (B₂, B₃, B₄, . . . Bₙ) have a natural resonance frequency (f_{RLi}) such that:
f_{RLi}=i×f_{F}
where
f_{RLi} is the natural resonance frequency of the i-th coil (Bᵢ) ,
i is a number varying from 2 to n,
f_{F} is the predetermined fundamental frequency.
each having an inductance (Lᵢ) such that, at the predetermined fundamental frequency (f_{F}):
L_{TOT}=L₁+L₂+ . . . Lᵢ+ . . . Lₙ=Z_{TOT}=Z₁+Z₂+ . . . Zᵢ+ . . . Zₙ
and
Lᵢ=Zᵢ
where
L_{TOT} is the total inductance of the “n” coils,
Lᵢ is the inductance of the i-th coil (Bᵢ),
Z_{TOT} is the total impedance of the “n” coils,
Zᵢ is the impedance of the “i-th” coil (Bᵢ),
n is an integer greater than zero.

2. The radiofrequency transmission device (D′) as claimed in claim 1, wherein the filtering means (30′) comprise three coils (B₁, B₂, B₃).

3. The radiofrequency transmission device (D′) as claimed in claim 1, wherein the predetermined fundamental frequency (f_{F}) is in the range from 310 MHz to 434 MHz.

4. A wheel unit, which comprises a radiofrequency transmission device (D′) as claimed in claim 1.

5. A hands free access badge for accessing a motor vehicle, wherein the hands free access badge comprises a radiofrequency transmission device (D′) as claimed in claim 1.

6. A motor vehicle, which comprises a radiofrequency transmission device (D′) as claimed in claim 1.

7. The radiofrequency transmission device (D′) as claimed in claim 2, wherein the filtering means (30′) comprise three coils (B₁, B₂, B₃).

8. A wheel unit, which comprises a radiofrequency transmission device (D′) as claimed in claim 2.

9. A wheel unit, which comprises a radiofrequency transmission device (D′) as claimed in claim 3.

10. A hands free access badge for accessing a motor vehicle, wherein the hands free access badge comprises a radiofrequency transmission device (D′) as claimed in claim 2.

11. A hands free access badge for accessing a motor vehicle, wherein the hands free access badge comprises a radiofrequency transmission device (D′) as claimed in claim 3.

12. A motor vehicle, which comprises a radiofrequency transmission device (D′) as claimed in claim 2.

13. A motor vehicle, which comprises a radiofrequency transmission device (D′) as claimed in claim 3.
